(19) United States
(12) Patent Application Publication
(10) Pub. No.: US 2026/0001302 A1
(43) Pub. Date: Jan. 1, 2026

(54) POLYISOCYANURATE AEROGEL COMPOSITE MATERIAL FOR BUILDING INSULATION

(71) Applicants: CARLISLE CONSTRUCTION MATERIALS, LLC, Carlisle, PA (US); LIATRIS, INC., Rockville, MD (US)

(72) Inventors: Gregory MOUNTAIN, Newville, PA (US); Myeongseob KIM, Rockville, MD (US); Lida LU, Rockville, MD (US); Jay THAKKAR, Carlisle, PA (US); Mikhail GELFER, Mechanicsburg, PA (US); Aparna JAGGI, Harrisburg, PA (US); William CRAWFORD, Carlisle, PA (US)

(73) Assignees: CARLISLE CONSTRUCTION MATERIALS, LLC, Carlisle, PA (US); LIATRIS, INC., Rockville, MD (US)

(21) Appl. No.: 19/249,398

(22) Filed: Jun. 25, 2025

Related U.S. Application Data
(60) Provisional application No. 63/665,433, filed on Jun. 28, 2024.

(51) Int. Cl. B32B 5/24; B32B 5/02; B32B 7/12; B32B 27/06; B32B 27/08; B32B 27/12

(52) U.S. Cl. CPC B32B 5/245; B32B 5/022; B32B 7/12; B32B 27/065; B32B 27/08; B32B 27/12; B32B 2250/03; B32B 2266/057; B32B 2266/126; B32B 2307/304

(57) ABSTRACT

A composite insulation assembly, including: (a) a bottom insulation layer, (b) a fiber supported aerogel blanket on top of the bottom insulation layer; and (c) a top insulation layer.

### RELATED APPLICATION

The present application claims priority from U.S. Provisional Patent Application Ser. No. 63/665,433, of same title, filed Jun. 28, 2024, incorporated herein by reference in its entirety for all purposes.

### TECHNICAL FIELD

The present invention relates to insulation materials formed by composites of Polyisocyanurate (PIR) and Aerosol Insulation.

### BACKGROUND OF THE INVENTION

Silica aerogels are typically loaded into fiber blankets and/or grown in situ in fiber reinforcement. They have extremely low densities and very low thermal conductivity (due to the large volume of gases trapped in the aerogel comprising the majority of the physical structure). Since silica aerogels have excellent thermal insulation properties, they would be well suited to provide insulation in applications such as building roofs and walls. Unfortunately, silica aerogels break very easily and are quite fragile to work with. As such, they are typically not suited to roofing insulation uses as they are easily damaged easily during roofing installation. It would instead be desirable to provide a form of silica aerogel insulation material that can be used easily and more broadly in roofing applications and building construction. As will be shown, the present system provides a silicon aerogel insulation composite ideally suited for such uses.

### SUMMARY OF THE INVENTION

In preferred aspects, the present system provides a composite insulation assembly having three layers with an aerogel layer as its middle layer between the other two insulation material layers. The advantage of this three layer design is that the aerogel layer is protected by the top and bottom layers such that an insulation product that is suitable for building and roofing construction is provided. In other preferred aspects, however, the present system provides a two layer composite insulation assembly having an insulation material on top of the aerogel layer.

In its preferred three layer embodiment, the present system provides a composite insulation assembly comprising: (a) a bottom insulation layer, (b) a fiber supported aerogel blanket on top of the bottom insulation layer; and (c) a top insulation layer on top of the fiber supported aerogel blanket.

In preferred aspects, the fiber supported aerogel blanket comprises a silica aerogel in a non-woven fiber support. The non-woven fiber support may be made of various materials, including but not limited to any one or more of: PET, polyester, polyethylene, polypropylene, polyamide, nylon, cellulose, cotton, hemp, jute, wool, carbon fiber, metal fiber, fiberglass, mineral wool, or ceramic fiber.

In preferred aspects, the top and bottom insulation layers may be made of various materials, including but not limited to, any one or more of: polyisocyanurate insulation, high density PIR coverboard or gypsum board. It is to be understood that the top and bottom insulation materials may be made of the same material or be made of different materials. For example, both the top and bottom layers may be made of rigid polyISO insulation, or both layers may be made of high density PIR coverboard, or one layer may be made of rigid polyISO insulation and the other layer may be made of high density PIR coverboard. Other possibilities are also contemplated, all keeping within the scope of the present invention.

In various preferred aspects, the fiber supported aerogel blanket may itself comprise a plurality of layers of fiber supported aerogel blanket layers that have been stacked together. Such stacked aerogel blanket layers may optionally be held together by any one or more of adhesives, staples, clips, or sown threads. Preferably, there are no metal skin layers in the present assembly.

In various aspects, the present composite assembly can be manufactured with the top insulation layer being poured directly onto the fiber supported aerogel blanket. Alternatively, the top insulation layer may be attached onto the fiber supported aerogel blanket by a solvent or by a water borne adhesive.

In the two layer embodiment of the present system, the top layer is simply removed. The bottom layer and the fiber supported aerogel blanket remain the same as described above. As will be explained, this two layer embodiment is particularly useful in situations where air at different temperatures is in contact with each of the two layers of the assembly (for example for use in a walk in freezer).

### BRIEF DESCRIPTION OF THE DRAWINGS

FIG. 1 is an illustration of a prototype of a PET supported aerogel blanket sandwiched between two layers of high density PIR coverboard (on the left) and a prototype of a PET supported aerogel blanket sandwiched between two layers of 20 psi PIR foam (on the right).

FIG. 2 is an illustration of a prototype of a PET supported aerogel blanket sandwiched between a high density PIR coverboard (on top) and 20 psi PIR foam (on the bottom). The PET aerogel mat in the middle is captured within.

### DETAILED DESCRIPTION OF THE DRAWINGS

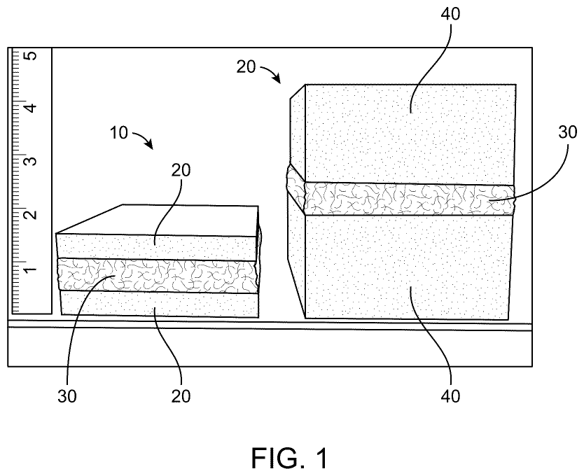

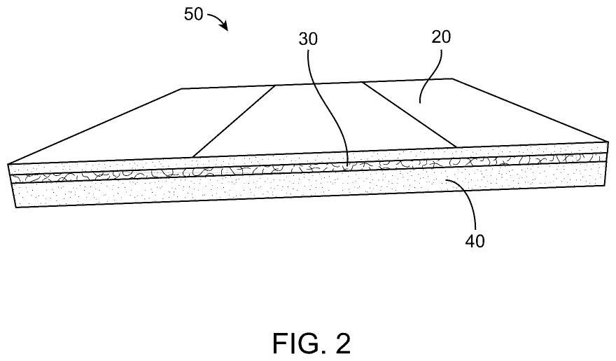

As seen in FIGS. 1 and 2, the present system provides a three layer composite insulation assembly 10 or 20 or 50, comprising:
a bottom insulation layer 20 or 40,
a fiber supported aerogel blanket 30 on top of the bottom insulation layer 20 or 40; and
a top insulation layer 20 or 40 on top of the fiber supported aerogel blanket 30.

In preferred embodiments, the fiber supported aerogel blanket 30 is made of a silica aerogel. Other aerogel materials are also possible, all keeping within the scope of the present invention. Also in preferred embodiments, the fiber supported aerogel blanket 30 comprises a non-woven fiber support. Such non-woven fiber support may preferably be made of any of the following materials (alone or in combination with one another): PET, polyester, polyethylene, polypropylene, polyamide, nylon, cellulose, cotton, hemp, jute, wool, carbon fiber, metal fiber, fiberglass, mineral wool, or ceramic fiber. It is to be understood that fiber supported aerogel blanket 30 may also be made of other suitable materials.

Also in preferred embodiments, the top and bottom insulation layers 20 and 40 may be made of any of the following materials (alone or in combination with one another): polyisocyanurate insulation, high density PIR coverboard or gypsum board.

As seen in FIG. 1, the top and bottom insulation layers 20 and 40 may be made of the same material. For example, FIG. 1 is an illustration of a prototype built by the present inventor showing a first composite insulation assembly 10 comprising a PET supported aerogel blanket 30 sandwiched between two layers of high density PIR coverboard 20 (on the left side of the photo) and a prototype of a PET supported aerogel blanket 30 sandwiched between two layers of 20 psi PIR foam 40 (on the right side of the photo).

As seen in FIG. 2, the top and bottom insulation layers 20 and 40 may be made of different materials. For example, FIG. 2 is an illustration of a prototype built by the present inventor showing a third composite insulation assembly 50 of a PET supported aerogel blanket 30 sandwiched between a high density PIR coverboard 20 (on top) and 20 psi PIR foam 40 (on the bottom). In this embodiment, the PET silica aerogel mat 30 is captured in the middle. The advantage of this three layer design is that the fragile center aerogel layer 30 is protected during shipping, handling and installation of the assembly into a building roof or wall.

In various alternate embodiments, the fiber supported aerogel blanket 30 itself comprises a plurality of separate layers of fiber supported aerogel blankets 30 stacked together one on top of the other. These separate layers of fiber supported aerogel blankets 30 may optionally be held together by one or more of adhesives, staples, clips, or sown threads.

Most preferably, the present assemblies 10, 20 or 50 are assembled with no metal skin layers in the assembly.

The present assemblies 10, 20 and 50 may be formed by the top insulation layer 20 or 40 being poured directly onto the fiber supported aerogel blanket 30. Alternatively, the top insulation layer 20 or 40 may instead be attached onto the fiber supported aerogel blanket 30 by a solvent or by a water borne adhesive.

In preferred embodiments, the aerogel layers may each be about 0.25″ thick with four of such layers stacked together such that fiber supported aerogel blanket 30 is approximately 1 inch thick. It is to be understood that adding additional layers (to form a composite middle layer 30) will result in increasing the insulation value of the overall assembly. The insulation value of the overall assembly could also be increased by making individual layer(s) 30 thicker as well. Insulation is characterized by thermal conductivity per ASTM C518 and measured in units of W/mK. Lower thermal conductivity means that there is less thermal transfer occurring across the material which is good for insulation applications.

Application of this invention covers continuous insulation in commercial construction (roofing and wall insulation). This product would be included in low slope roofing systems and/or high slope roofing applications in combination with metal roofing materials. In the wall it would be used as continuous insulation in combination with brick, masonry, and metal façade applications. Additional applications include residential use in building envelope insulation and roofing insulation applications.

In a second preferred embodiment, the top insulation layer is removed to provide a two-layer composite. This embodiment provides a composite insulation assembly, comprising:
a bottom insulation layer 20 or 40, and
a fiber supported aerogel blanket 30 on top of the bottom insulation layer 20 or 40.

Similar to the three layer embodiment described above, the present two layer system uses the same materials having the same properties. Specifically, layer 30 may comprise a silica aerogel in a fiber supported aerogel blanket made of any of: PET, polyester, polyethylene, polypropylene, polyamide, nylon, cellulose, cotton, hemp, jute, wool, carbon fiber, metal fiber, fiberglass, mineral wool, or ceramic fiber. Separate layers of fiber supported aerogel blanket may be stacked one on top of the other and held together as described above. The bottom insulation layer may be made of polyisocyanurate insulation, high density PIR coverboard or gypsum board.

This two layer composite is especially useful in the following situation. The thermal conductivity of PIR insulation (layer 40) using liquid blowing agents like pentane generally increases as application temperature decreases below ˜50° F. However, the thermal conductivity of aerogel insulation (layer 30) decreases as application temperature decreases below room temperature (70° F.). This means that by producing composite insulation assembles where the aerogel layer 30 is included on the cold side of the assembly (most exterior face for building applications OR internal face for cold storage applications) the efficiency of the PIR layer 40 is increased dramatically, especially for cold storage applications or severe cold climates while providing the cost competitive aspect of PIR foam.

What is claimed is:

1. A composite insulation assembly, comprising:
a bottom insulation layer,
a fiber supported aerogel blanket on top of the bottom insulation layer; and
a top insulation layer.

2. The assembly of claim 1, wherein the fiber supported aerogel blanket is a silica aerogel.

3. The assembly of claim 1, wherein the fiber supported aerogel blanket comprises a non-woven fiber support.

4. The assembly of claim 3, wherein the non-woven fiber support comprises at least one of:
PET, polyester, polyethylene, polypropylene, polyamide, nylon, cellulose, cotton, hemp, jute, wool, carbon fiber, metal fiber, fiberglass, mineral wool, or ceramic fiber.

5. The assembly of claim 1, wherein the top and bottom insulation layers comprise at least one of:
polyisocyanurate insulation, high density PIR coverboard or gypsum board.

6. The assembly of claim 3, wherein the top and bottom insulation layers are made of the same material.

7. The assembly of claim 3, wherein the top and bottom insulation layers are made of different materials.

8. The assembly of claim 1, wherein the fiber supported aerogel blanket comprises a plurality of layers of fiber supported aerogel blankets stacked together.

9. The assembly of claim 8, wherein the layers of fiber supported aerogel blankets are held together by one of:
adhesives, staples, clips, or sown threads.

10. The assembly of claim 1, wherein there are no metal skin layers in the assembly.

11. The assembly of claim 1, wherein the top insulation layer is poured directly onto the fiber supported aerogel blanket.

12. The assembly of claim 1, wherein the top insulation layer is attached onto the fiber supported aerogel blanket by a solvent or water borne adhesive.

13. A composite insulation assembly, comprising:
a bottom insulation layer, and
a fiber supported aerogel blanket on top of the bottom insulation layer.

14. The assembly of claim 13, wherein the fiber supported aerogel blanket is a silica aerogel.

15. The assembly of claim 13, wherein the fiber supported aerogel blanket comprises a non-woven fiber support.

16. The assembly of claim 15, wherein the non-woven fiber support comprises at least one of:
PET, polyester, polyethylene, polypropylene, polyamide, nylon, cellulose, cotton, hemp, jute, wool, carbon fiber, metal fiber, fiberglass, mineral wool, or ceramic fiber.

17. The assembly of claim 1, wherein the bottom insulation layer comprises at least one of:
polyisocyanurate insulation, high density PIR coverboard or gypsum board.

18. The assembly of claim 13, wherein the fiber supported aerogel blanket comprises a plurality of layers of fiber supported aerogel blankets stacked together.

19. The assembly of claim 18, wherein the layers of fiber supported aerogel blankets are held together by one of:
adhesives, staples, clips, or sown threads.
